(19) United States
(12) Patent Application Publication
(10) Pub. No.: US 2011/0147524 A1
(43) Pub. Date: Jun. 23, 2011

(54) FIRE DETECTION SYSTEM AND METHOD FOR CONFIGURING A FIRE DETECTION SYSTEM

(75) Inventors: Kai Behle, Stuhr (DE); Frank- Peter Riemer, Edewecht (DE); Michael Dietl, Hamburg (DE); Joerg Boesch, Buxtehude (DE)

(73) Assignee: AIRBUS OPERATIONS GMBH, Hamburg (DE)

(21) Appl. No.: 13/060,317

(22) PCT Filed: Aug. 24, 2009
(86) PCT No.: PCT/EP2009/060867

§ 371 Date: Mar. 7, 2011

Related U.S. Application Data
(60) Provisional application No. 61/190,025, filed on Aug. 25, 2008.

(30) Foreign Application Priority Data
Aug. 25, 2008 (DE) 10 2008 039 636.2

(51) Int. Cl. B64D 45/00; G08B 17/10; G06F 19/00

(52) U.S. Cl. 244/129.2; 340/945; 702/24

(57) ABSTRACT

The invention relates to a fire detection system comprising one or several fire sensors, in which fire detection system a monitoring unit communicates with the fire sensors and by way of a configuration unit may be configured by means of configuration data, wherein the configuration data comprises information relating to the fire sensors within the means of transport, which fire sensors are to be used in the means of transport. The invention further comprises a method for configuring a fire detection system and an aircraft comprising such a fire detection system.

### RELATED APPLICATIONS

This application claims the benefit of the filing date of U.S. Provisional Patent Application No. 61/190,025, filed Aug. 25 2008 and of German Patent Application 10 2008 039 636.2, filed Aug. 25, 2008, the disclosure of which applications is hereby incorporated herein by reference.

### TECHNICAL HELD

The invention relates to a fire detection system for a means of transport, to a method for configuring a fire detection system, and to an aircraft comprising at least one such fire detection means.

### BACKGROUND OF THE INVENTION

According to requirements by aviation authorities, fire warning systems or smoke warning systems which have been, for example, developed for aviation, must be installed in all the spaces of an aircraft that are not continuously occupied. This means that when in an aircraft, for example apart from passenger cabins comprising seats there are also rest compartments for the cabin crew, the fire detection system must also monitor these spaces because rest compartments are not occupied during the entire duration of flight. As a rule, monitoring is provided by a combination of a monitoring device (also known as an electronic central fire alarm system) and sensors (fire sensors and/or smoke warning emitters) that are arranged in the spaces to be monitored. In this arrangement the sensors are connected to the monitoring device by means of connection means in the form of a supply network or the like.

Documents DE 10 2004 034 904 A1 and US 2008 0061996 A1 show smoke warning systems in which several smoke warning emitters are arranged in a cabin of an aircraft and are connected by way of data lines to a monitoring device in the form of an evaluation device.

The monitoring device, the sensors and the connection means between the sensors and the monitoring device must normally be certified for proper operation within an aircraft by the corresponding aviation authorities. This furthermore means that these installations must be subjected to a certification process.

In this connection it is important to mention that during evaluation of the criticality of systems in modern commercial aircraft, a categorisation according to the effects which possible faults can have on (flight) safety is carried out. According to their criticality, functions are classified in five different grades (A-E) extending from functions that are extremely critical to safety (grade A) to functions that are completely non-critical (grade E). Depending on the grade, a development process applies that matches the criticality and that is checked during certification of the corresponding system, with this grade also being known as the “design assurance level” (DAL). In the state of the art the above fire detection system is usually designated “DAL B”. Once a system has been certified for a particular aircraft, said system must no longer be changed because otherwise the entire approval process or certification process is to be undertaken anew.

In particular in the case of monitoring spaces in an aircraft it is clear that in the initial approval, for example of a determined fire detection system, it is impossible to anticipate all the options for dividing the cabin into various spaces, which options will be offered in the future. In the course of ongoing further development of the aircraft type, which reflects changed requirements by aircraft operators and the like, more or less drastic changes in the partitioning of the cabin can be carried out. Accordingly it is necessary, after adaptation to current specifications, for a system that was certified to undergo renewed certification.

Presently it is normal, already at the planning stage and prior to certification of the fire detection system, for each imaginable optional request by an aircraft operator to provide a plug-in contact on the monitoring device. Monitoring of each optional space is then activated by means of connecting the corresponding contact to the ground of the aircraft. Since as a result of this, optionally a multitude of sub-functions can be enabled or removed, this method is also referred to as “pin programming”. This example shows that a large number of contacts are required to meet a multitude of possible requests from aircraft operators. However, the number of contacts in a connector is limited by the connector housing which in turn is predetermined by maximum connector size. In addition, individual contacts need to be individually wired for each aircraft operator and each aircraft so that significant additional work is involved, as is significant increased aircraft weight as a result of the number of unused options which are nevertheless provided. Furthermore, it should be mentioned that in the monitoring device—provided it is programmed by way of corresponding calculation algorithms—complete software modules must already exist that are activateable by means of the above-mentioned pin programming. Consequently not only is programming of the monitoring device complex, but for example during first-time application there can, for example, be no new space without a software change. This would, however, require renewed certification taking into account a development process of category DAL B.

### SUMMARY OF THE INVENTION

It is the object of the invention to provide a method for fire monitoring or smoke monitoring in a means of transport, which method can be adapted as flexibly as possible to the spaces to be integrated in the means of transport, and which during a change in the configuration to the greatest extent possible requires only simplified certification. Likewise, it is the object of the invention to propose a method for configuring a fire detection system, which method also reduces the expenditure of certification work or adaptation work. It is a further object of the invention to propose a fire detection system and a means of transport comprising at least one fire detection system with the above-mentioned advantages.

The object is met by a fire detection system comprising one or several fire sensors for detecting fire and/or smoke emission, as well as a monitoring unit, a configuration unit, at least one sensor interface for connecting the monitoring unit to the fire sensors, and at least one configuration interface for connecting the monitoring unit to the configuration module, wherein the monitoring unit is configured to transmit signals by way of the sensor interface to the fire sensors, and to receive signals from the fire sensors, wherein the configuration module comprises memory means for storing configuration data and is designed to transmit the configuration data by way of the configuration interface to the monitoring unit, and wherein the configuration data defines fire sensors that are to be used by the fire detection system. Transmitting the configuration data to the monitoring unit preferably takes place on request by the monitoring unit. However, in principle the fire detection system according to the invention is not limited to this.

A fire detection system designed according to the principle according to the invention thus as a main function or core function comprises a monitoring unit that by way of an interface can be connected to any number of sensors. It is not necessary to specify all the possible positions of fire sensors already in the monitoring unit before activating the latter by way of pin programming, which in principle is comparable to flicking a switch. All the data concerning fire sensors can be stored in the configuration module and this configuration can be transmitted to the monitoring unit, if required alternatingly, regularly and the like. In this way there is no need to provide physically present individual pin-programming lines, nor is there any binding to spaces within the means of transport, which spaces are to be specified already during the design of the monitoring unit.

Likewise this functional division makes it possible to certify and register the monitoring unit according to the applicable directives and regulations. The monitoring unit is subjected to a DAL B development process and is certified following corresponding approval. As a result of the separation of functions any changes in the configuration of the means of transport do not result in the monitoring unit having to be certified anew and accordingly also having to undergo a renewed DAL B development process. Only the configuration module that configures the monitoring unit would have to be subjected to an easier certification test (for example DAL D), so that significant savings in time and expenditure result. The discrepancy that results between the two grades DAL D and DAL B used in the example then needs to be compensated for. The DAL D development process relating to the configuration module requires a manual one-off test to validate the configuration data from the lower-level DAL D development process for higher-level DAL B. In the present case this test could, for example, be carried out in the context of the aircraft certification test, which takes place anyway.

The term “fire sensors” relates to the type of sensor that is suitable for detecting the presence of fire and/or smoke and/or strong heat emission. The fire detection system according to the invention is not limited to a single type of sensor that is only suitable for detecting a single isolated physical parameter. Fire sensors in the sense of the invention can thus comprise optical sensors for detecting flames, acoustic sensors and the like, as well as temperature sensors, smoke detectors and similar.

In an advantageous improvement of the fire detection system according to the invention the configuration module is adapted for storing a base configuration and an optional configuration. This makes it possible to already specify a basic configuration relating to each means of transport to be produced, and depending on the request from the operator of the means of transport to accommodate optional spaces and fire sensors arranged therein in an optional configuration. In this manner it is already possible to check and certify a base configuration so that only the optional configuration needs to be correspondingly checked.

In an advantageous improvement of the fire detection system according to the invention the configuration in each case comprises at least one communication address of the fire sensors. Consequently, in the case of communication between the monitoring unit and the fire sensors by way of a bus system or a network system, the use of lines with low cross sections is made possible, which lines can be used by several fire sensors jointly. For unequivocal identification of the fire sensors the respective communication addresses are necessary. With this, by means of configuration, in a simple manner both the position and the availability of the fire sensor can reliably be provided.

In a particularly advantageous fire detection system according to the invention the monitoring unit is configured to send a status request by way of the fire sensor interface to the fire sensors; furthermore, the monitoring unit is configured to receive, by way of the fire sensor interface, response signals emitted by fire sensors. In this way, in particular during initialisation of the fire detection system according to the invention, a determination can be made as to whether all the fire sensors specified in the configuration are available in that they respond to the request sent out.

It is further preferred for the monitoring unit for monitoring the availability of the fire sensors to be configured to compare the response signals from the fire sensors with all the fire sensors that are to be used and that are defined in the configuration data.

Finally, in an advantageous fire detection system according to the invention the monitoring unit is designed, when a fire has been reported by at least one fire sensor, to generate an alarm signal and to transmit it to at least one output means. In this way the actual function of the fire detection system is ensured, for a detected fire can, in the form of an alarm signal, for example in a commercial aircraft, be transmitted to an optical display unit and/or an acoustic signalling device, by means of which a pilot or some other crew member is warned.

Finally, it is preferred if the configuration module is adapted for reading the configuration data from a data carrier. Said data carrier can easily be provided outside the means of transport with the necessary configuration data and can then be placed on board of the means of transport prior to initialisation of the fire detection system according to the invention, so that down times of the means of transport can be reduced.

The object is further met by a method for configuring a fire detection system, with the method comprising the steps of: transmitting configuration data from a configuration module by way of at least one configuration interface to a monitoring unit, wherein the configuration data defines fire sensors that are to be used by the fire detection system; transmitting signals from the monitoring unit to one or several fire sensors; receiving response signals from the fire sensors by the monitoring unit; comparing the available fire sensors, determined from the response signals of the fire sensors, with the fire sensors to be used, which fire sensors are predetermined by the configuration data. By means of such a configuration of the fire detection system it can automatically be ensured that the specified data can be implemented by means of a programmed configuration module or a configuration module that comprises data. In this manner the reliable use of the fire detection system is ensured.

In an advantageous improvement of the method according to the invention for configuring a fire detection system the configuration data is divided for a base configuration and an optional configuration. Due to the advantages already mentioned above, this is particularly preferred because optional designs within the means of transport can be checked as quickly as possible.

Finally, it is preferred if the monitoring unit sends a warning signal to an output means should not all the fire sensors to be used from the configuration data be available. Consequently it is easily possible, for example by the person in charge of the means of transport, to detect that there is a problem with the fire detection system.

### SHORT DESCRIPTION OF THE DRAWINGS

Further characteristics, advantages and application options of the present invention are disclosed in the following description of the exemplary embodiments and of the figures. All the described and/or illustrated characteristics per se and in any combination form the subject of the invention, even irrespective of their composition in the individual claims or of their interrelationships. Furthermore, identical or similar components in the figures have the same reference characters. The following are shown:

FIG. 1: a configuration of a fire detection system in the state of the art;

FIG. 2: a configuration according to the invention of a fire detection system;

FIG. 3: a diagrammatic view of a fire detection system according to the invention;

FIG. 4: a diagrammatic view of a method according to the invention for configuring a fire detection system; and

FIG. 5: an aircraft comprising at least one fire detection system according to the invention.

### DETAILED DESCRIPTION OF EXEMPLARY EMBODIMENTS

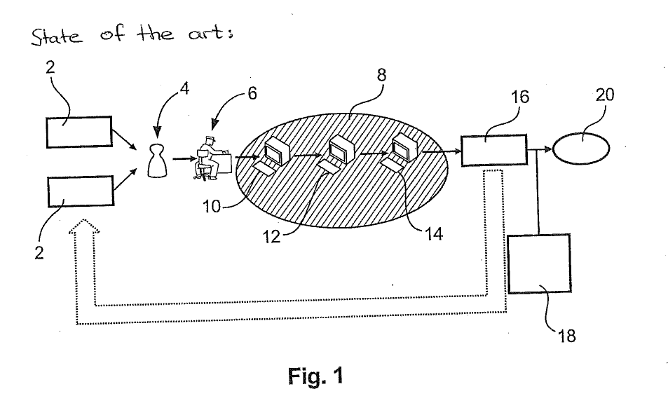

FIG. 1 shows how a fire detection system in a means of transport, and in particular in a commercial aircraft, is usually configured. After the higher-level requirements (also known as “top level requirements”) 2 have been determined, there follows an analysis 4, in which, for example, the number and the positioning of fire detection sensors is determined. From this the specification 6 of the monitoring unit is determined, wherein the monitoring unit is programmed by means of software. In this process a DAL B development process 8 must be undergone, which apart from the individual steps of software development 10 also comprises software integration 12 and software testing 14. On completion of the development process 8 the monitoring unit can be installed 16 on board the aircraft. Configuration then takes place by means of electronic pin-programming 18 by way of a so-called configuration module (“cabin assignment module”, CAM), whereupon the fire detection system is ready for operation 20. If it is necessary to provide new spaces 22 within the aircraft, the entire process of analysis 4, of specification 6, and of development 8 with certification must be carried out anew. This involves relatively high costs and substantial time delays during production of the means of transport or aircraft.

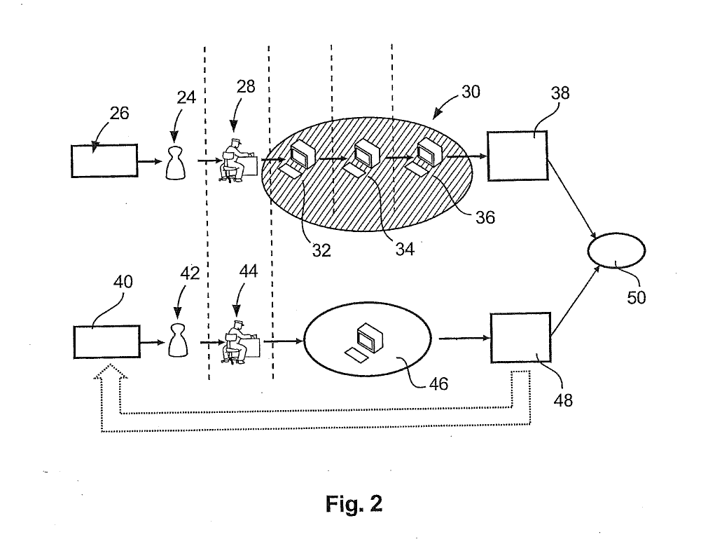

FIG. 2 shows a modification of the configuration of a fire detection system according to the aspects according to the invention. After analysis 24 of the basic requirements 26 of the fire detection system, specification 28 of a monitoring unit takes place with the subsequent DAL B development process 30 which comprises the partial steps of software development 32, software integration 34 and software testing 36. Thereafter, following successful certification, the fire detection system can be installed 38 in the aircraft. Adaptation of the fire detection system according to the invention by spaces 40 that are to be defined anew first takes place by means of an analysis 42 of the specification 44 of a cabin configuration module and a subsequent DAL D development process 46 which essentially comprises checking the additions made to the configuration module in relation to the position and communication address of one or several fire sensors, wherein this certification is significantly less elaborate and expensive than a DAL B process 30. Thereafter the fire detection system or the configuration module can be installed 48 in the aircraft, from where the monitoring unit is in a position in operation 50 to call up the new configuration from the configuration module.

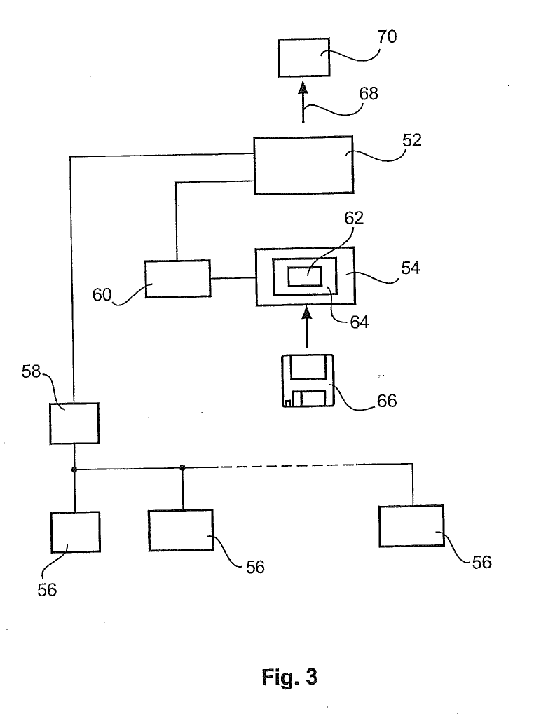

The fire detection system according to the invention essentially comprises a monitoring unit 52, a configuration module 54, one or several fire sensors 56, at least one fire sensor interface 58 and at least one configuration interface 60, as shown in FIG. 3. The monitoring unit 52 is designed to communicate with the configuration module 54 by way of the configuration interface 60. Accordingly, the configuration module is able, on call, to transmit to the monitoring unit 52 a configuration in the form of configuration data 62 that is stored in memory means 64 within the configuration module. In this arrangement the configuration data 62 can originate from a data carrier 66 that is selected by the configuration module 54. The monitoring unit 52 is further designed to communicate with the fire sensors 56 by way of the fire sensor interface 58 so that the monitoring unit 52 can, for example, prompt the fire sensors to send an availability status to the monitoring unit 52. If, for example, the fire detection system according to the invention is initialised, the monitoring unit 52 can emit a signal to all the fire sensors 56, wherein the fire sensors 56 react to said signal by transmitting position data or address data. From the data received back from the fire sensors 56 the monitoring unit 52 can determine whether all the fire sensors predetermined in the configuration data 62 are indeed physically present and can react to requests. If this is the case, the monitoring unit 52 can assume that the fire detection system according to the invention functions properly. If the above is not the case, a warning signal 68 can be sent to an output means 70.

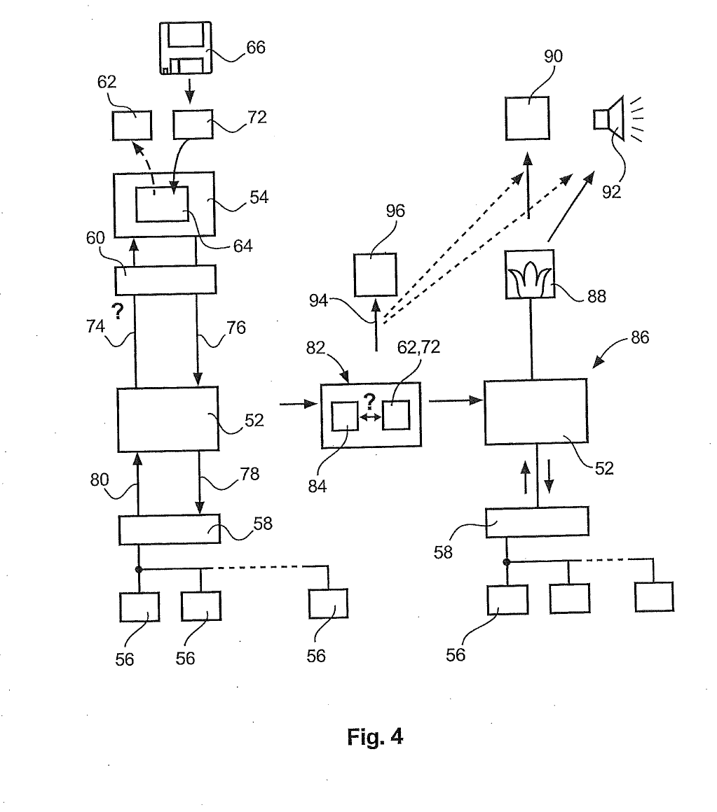

If reconfiguration of the fire detection system according to the invention is required, the configuration module 54, as shown in FIG. 4, needs to be supplied with new configuration data 72, wherein the original configuration data 62 can in principle be deleted or removed from the memory means 64. As an alternative to the aforesaid it is also imaginable for the configuration data 62 to represent a base configuration which need not be deleted from the memory means 64. For this reason the arrow directed from the memory means 64 to the configuration data 62 is dashed. At this point it should be mentioned that the configuration data can be made available on data carriers 66 which can be transmitted to the memory means 64 by way of the usual wired or wireless interfaces. For example removable data carriers 66 such as diskettes, read-only memories or the like are imaginable, which following reconfiguration of the spaces of the means of transport can be made to initialise the fire detection system or similar by way of a corresponding interface to the configuration module 54, can be read out in that location and can finally be removed again. Accordingly, the term “memory means” 64 refers to a volatile or non-volatile main memory integrated in the configuration module 54. On the other hand the memory means 64 can also refer to a data carrier that except for the configured fire detection system according to the invention remains in the configuration module 54, and it can be ensured that the fire detection system, once configured, retains, until the next re-configuration of the spaces, the data relating to the fire sensors to be used.

Following updating of the configuration data, the monitoring unit 52 sends a request 74 to the configuration module 54 which communicates 76 the then current configuration data 72. Thereafter the monitoring unit 52 is in a position to prompt 78 all the fire sensors 56, by way of the fire sensor interface 58, to send feedback relating to availability as well as sending 80 a communication address. Subsequently, the monitoring unit 54 can check 82 whether found fire sensors 84 tally with all fire sensors defined in the configuration data 72 or 62 and 72 in the case of separate base configuration data and optional configuration data. Thereafter the monitoring unit 54 can continue implementing fire monitoring 86. To this effect the monitoring unit 54 regularly communicates with the installed fire sensors 56 and queries their status. If one of the fire sensors 56 detects a fire, the monitoring unit 54 is, furthermore, adapted for emitting an alarm signal 88 which, for example, can be forwarded to an optical 90 and/or acoustic output unit 92 which in the case of an aircraft is, for example, located in the cockpit.

If during a comparison 82 of the found fire sensors 84 with the fire sensors to be used, defined by the configuration data 72, it is detected that not all the fire sensors are available, a warning signal 94 can be issued to an output means 96, which warning signal 94, for example, warns the person in charge of the means of transport. As an alternative to the separate output means 96, it is also possible to use the output means 90 and 92 of the fire detection 86.

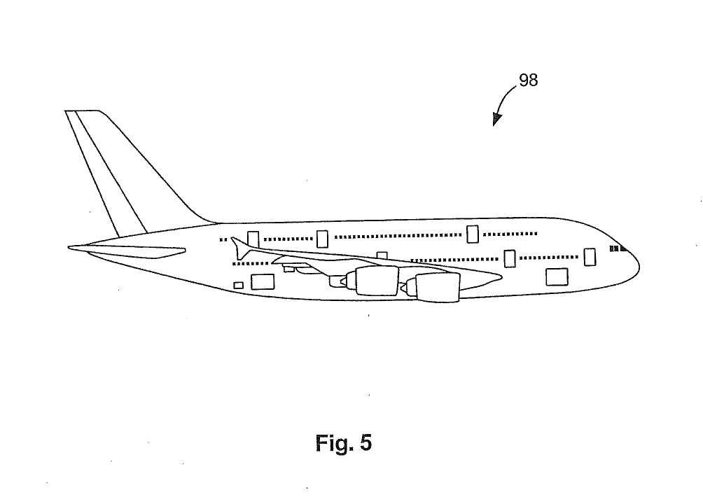

Finally, FIG. 5 shows an aircraft 98 in which at least one fire detection system according to the invention is integrated so that the aircraft 98 can be reconfigured in a particularly flexible manner without their being a need to do without DAL B fire detection.

In addition, it should be pointed out that “comprising” does not exclude other elements or steps, and “a” or “one” does not exclude a plural number. Furthermore, it should be pointed out that characteristics or steps which have been described with reference to one of the above exemplary embodiments can also be used in combination with other characteristics or steps of other exemplary embodiments described above. Reference characters in the claims are not to be interpreted as limitations.

### REFERENCE CHARACTERS

2 Determine requirements

4 Analysis

6 Specification

8 DAL B development process

10 Software development

12 Software integration

14 Software testing

16 Install

18 Pin-programming

20 Operational readiness

22 Provide new spaces

24 Analysis

26 Basic requirements

28 Specification

30 DAL B development process

32 Software development

34 Software integration

36 Software testing

38 Install

40 Spaces to be determined anew

42 Analysis

44 Specification

46 DAL D development process

48 Install

50 Operation

52 Monitoring unit

54 Configuration module

56 Fire sensor

58 Fire sensor interface

60 Configuration interface

62 Configuration data

64 Memory means

66 Data carrier

68 Warning signal

70 Output means

72 Current configuration data

74 Request to configuration module

76 Advise current configuration data

78 Prompt feedback from fire sensors

80 Transmit feedback

82 Check

84 Fire sensors found

86 Fire monitoring

88 Alarm signal

90 Optical output unit

92 Acoustic output unit

94 Warning signal

96 Output means

98 Aircraft

1. A fire detection system for an aircraft with a plurality of spaces, comprising:
one or more fire sensors for detecting at least one of fire smoke emission;
at least one monitoring unit;
at least one configuration module;
at least one sensor interface for connecting the at least one monitoring unit to the fire sensors; and
at least one configuration interface for connecting the at least one monitoring unit to the at least one configuration module;
wherein the at least one monitoring unit is configured to transmit signals to the fire sensors via the at least one sensor interface and to receive signals from the fire sensors;
wherein the at least one configuration module comprises memory means for storing configuration data and is designed to transmit the configuration data to the monitoring unit via the at least one configuration interface;
wherein the configuration data is divided into a base configuration and an optional configuration;
wherein the configuration data defines fire sensors that are to be used by the fire detection system;
wherein the fire sensors are adapted for signalizing a proper function thereof;
wherein the at least one monitoring unit is adapted for sending a status request to the fire sensors via the at least one sensor interface and to receive response signals emitted by the fire sensors via the at least one sensor interface; and
wherein the at least one monitoring unit for monitoring the availability of the fire sensors is configured to compare the response signals from the fire sensors with all the fire sensors that are to be used and that are defined in the configuration data.

2. The fire detection system of claim 1, wherein the monitoring unit is produced according to a DAL B development process and the configuration module according to a DAL D development process.

3. The fire detection system of claim 1, wherein the configuration data comprises at least one communication address of the fire sensors.

4. The fire detection system of claim 1, wherein the at least one monitoring unit is designed to generate an alarm signal and to transmit the alarm signal to at least one output means when at least one of fire or smoke emission has been reported by at least one of the fire sensor.

5. The fire detection system of claim 1, wherein the at least one configuration module is adapted for reading the configuration data from a data carrier.

6. A method for configuring a fire detection system, comprising:
transmitting configuration data from a configuration module to a monitoring unit via at least one configuration interface, wherein the configuration data defines fire sensors that are to be used by the fire detection system for detecting at least one of fire or smoke emission and is divided into a base configuration and an optional configuration;
transmitting signals from the monitoring unit to one or more fire sensors via at least one sensor interface for a status request;
receiving response signals from the fire sensors by the monitoring unit for signalizing a proper function; and
comparing the available fire sensors, determined from the response signals, with the fire sensors to be used as predetermined by the configuration data.

7. The method of claim 6, wherein the monitoring unit is produced according to a DAL B development process and the configuration module according to a DAL D development process

8. The method of claim 6, wherein the configuration data comprises one or more communication addresses of the fire sensors to be used.

9. The method of claim 6, wherein a warning signal is sent to at least one output means if not all the fire sensors to be used as predetermined by the configuration data available.

10. The method of claim 6, wherein the configuration data is inputted into the configuration module via a data carrier.

11-12. (canceled)

13. An aircraft comprising at least one fire detection system of claim 1.
